(19) United States
(12) Patent Application Publication
(10) Pub. No.: US 2007/0184696 A1
(43) Pub. Date: Aug. 9, 2007

(54) Device for parallel connection of a plurality of electrical feeder units

(75) Inventors: Julien Melot, Grenoble (FR); Pierre Olivier Salla, Lancey (FR); Miao-Xin Wang, ShenZhen (CN)

Correspondence Address: STEPTOE & JOHNSON LLP, 1330 CONNECTICUT AVENUE, N.W., WASHINGTON, DC, 20036, US

(73) Assignee: MGE UPS SYSTEMS, St. Ismier (FR)

(21) Appl. No.: 11/698,052

(22) Filed: Jan. 26, 2007

(30) Foreign Application Priority Data
Feb. 3, 2006 (FR) 06 00989

(51) Int. Cl. H01R 4/60

(52) U.S. Cl. 439/215

(57) ABSTRACT

The device for parallel connection of a plurality of electrical feeder units comprises a power output socket, and for each feeder unit:
a connector equipped with a power input plug, and
at least one power conductor between said plug and the output socket.

The connector comprises detection means designed to detect connection of said connector to the feeder unit.

A controlled switch equipped with a control input is connected in series on the at least one power conductor, said control input being coupled to the detection means, detection of connection of the connector to the feeder unit enabling closing of said switch.

### BACKGROUND OF THE INVENTION

The invention relates to the field of electrical feeder units and implementation thereof

The invention relates more particularly to a device for parallel connection of electrical feeder units comprising at least one power output socket designed to deliver electrical power supplied by the plurality of units, and comprising for each unit:
a connector equipped with a power input plug designed to be connected to a first electrical output of a unit, and
at least one power conductor between said power input plug and the power output socket.

### STATE OF THE ART

It is known to use one such device for parallel connection of electrical power supply units, for example inverters, in order to supply a larger electrical power to a load than that supplied by any one of these power units or to supply power even when one of the electrical power supplies is out of service.

When such a connection device is implemented, it is often possible and/or necessary to disconnect one of the electrical power supply units, for example to replace the latter or to carry out maintenance operations. Disconnecting the power input connectors of the connection device may be a source of danger. Indeed, the connector thus disconnected is generally of the plug type and presents an electrical voltage on its pins supplied by the other power units via the output socket and the power conductors.

### SUMMARY OF THE INVENTION

The object of the present invention is to provide a device for parallel connection of a plurality of electrical feeder units enabling one of the units to be disconnected without any risk of electrocution for the user.

The connection device comprises at least one power output socket designed to supply electrical power provided by the plurality of supply units, and comprises for each unit:
a connector equipped with a power input plug designed to be connected to a first electrical output of a unit, and
at least one power conductor between said power input plug and the power output socket.

According to the present invention:
the connector comprises detection means designed to detect connection of said connector to the unit, and
at least one controlled switch is connected in series to said at least one power conductor, the at least one controlled switch comprising a control input, said control input being coupled to the detection means, detection of connection of the connector to the unit enabling closing of said at least one controlled switch.

According to one embodiment, the detection means comprise means for detecting continuity of electrical conduction. Preferably, the means for detecting continuity of electrical conduction are applied to the grounds. Advantageously, the means for detecting continuity of electrical conduction comprise a transformer. Preferably, the transformer is equipped with:
a primary winding each end whereof is connected to a power conductor of the power input plug, and
a secondary winding connected in series with a ground conductor of the power input plug.

According to another embodiment, the detection means comprise a contactor. In one case, the contactor of the detection means can be a mechanical contactor, connection of the connector to the unit being detected by mechanical activation of the contactor. In another case, the contactor of the detection means can be an optical contactor, connection of the connector to the unit being detected by optical activation of the contactor. In yet another case, the contactor of the detection means can be a ground contactor, connection of the connector to the unit being detected by a placing a ground associated with the connector in contact with a ground of the unit.

According to another embodiment,
the detection means comprise a control connector designed to be connected to a second electrical output of the unit, said control connector operating in conjunction with the power input plug so that, when the connector is connected to the unit, an electrical contact between the first output and the power input plug is established substantially at the same time or subsequent to establishment of an electrical contact between the second output and the control connector, and
the control input is coupled to the control connector, establishment of an electrical contact between the second output of the unit and the control connector enabling closing of said at least one controlled switch.

Preferably, the power input plug and the control connector are securedly affixed to one another and the direction of insertion of said plug and connector are the same. In one case, the power input plug and the control connector are assembled by overmoulding or moulding. In another case, the power input plug and the control connector are fitted on a metal or plastic housing.

Advantageously, the control connector is connected to the output socket by at least one additional power conductor, at least one additional controlled switch being connected in series to said at least one additional power conductor, said at least one additional controlled switch being associated with the control input.

According to a particular embodiment of the invention, the device comprises, for each unit of the plurality of electrical feeder units:
at least one monitoring connector designed to be connected to at least one monitoring output of the unit delivering monitoring signals representative of the state of operation of said unit, and
the control input of the at least one controlled switch is also coupled to the monitoring connector so that closing of said at least one controlled switch can only be activated if the at least one monitoring connector is connected to the monitoring output and if the monitoring signals are representative of normal operation.

Preferably, the control input of the at least one switch is coupled to the monitoring connector by a second control input of a second controlled switch connected in series between the control connector and said control input.

According to a particular embodiment of the invention, the at least one controlled switch, for each unit, is fitted in the connector. Preferably, the at least one power output socket is fitted on least one connector.

According to a particular embodiment of the invention, the at least one power output socket is fitted on an output housing. Preferably, the device further comprises communication connectors and means for communication between said communication connectors, said connectors being designed to be connected with communication outputs of each unit. In one case, the at least one controlled switch, for each unit, can be fitted in the output housing. In another case, the at least one controlled switch, for each unit, can be fitted in the connector.

Preferably, the electrical feeder units are inverters.

Preferably, the connection device is suitable for connection of two electrical feeder units in parallel.

### BRIEF DESCRIPTION OF THE DRAWINGS

Other advantages and features will become more clearly apparent from the following description of particular embodiments of the invention, given as non-restrictive examples only, and represented in the accompanying figures.

FIG. 1 represents an embodiment of the connection device wherein the power output socket is fitted on an output housing and wherein controlled switches are fitted in said output housing.

FIG. 2 represents an example of a connector wherein the power input plug and the control connector are integral to one another, and also represents the face of the unit whereto the connector is designed to be connected.

FIG. 3 represents an embodiment of the connection device wherein a power output socket is fitted on an output housing and wherein the controlled switch equipping each power conductor is fitted in the connector connected to said conductor.

FIG. 4 represents an embodiment of the connection device wherein the controlled switch equipping each power conductor is fitted in the connector connected to said conductor and a power output socket is fitted on each connector.

FIG. 5 represents an embodiment of the connection device comprising first and second detection means designed to detect connection of the connector.

FIG. 6 represents an embodiment of the connection device wherein the detection means comprise means for detecting ground continuity.

### DETAILED DESCRIPTION OF AN EMBODIMENT

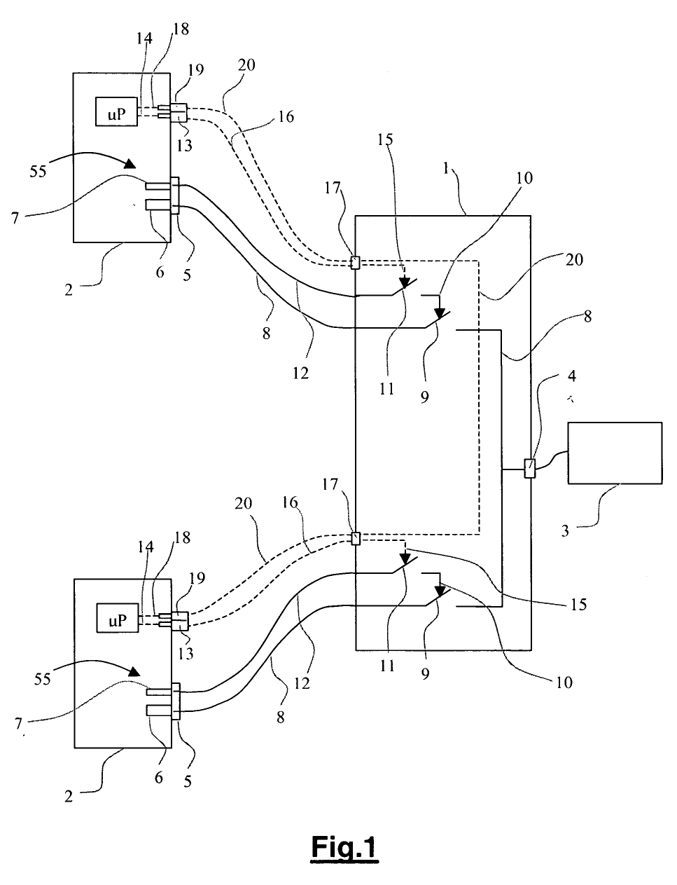

The connection device represented in FIG. 1 comprises an output housing 1 and enables two inverters 2 to be connected in parallel so as to supply a larger electrical power than that supplied by a single inverter to a load 3, via the output housing. For this purpose, the output housing of the connection device comprises a power output socket 4 designed to deliver an electrical power supplied by the two inverters to the load 3.

The connection device also comprises a connector 5, for each of the inverters, designed to be connected to outputs of the inverter. The connector comprises a power input plug 6 designed to be connected to a first electrical output of the inverter. The connector 5 also comprises detection means 55 designed to detect connection of said connector to the unit. These detection means comprise a control connector 7, in the form of a plug, designed to be connected to a second output of the inverter. The plugs 6 and 7 of the connector 5 co-operate with one another in such a way that their directions of insertion in the inverter outputs are oriented in the same direction, which enables a substantially simultaneous electrical contact to be established between said plugs 6 and 7 on the one side, and the first and second output sockets of the inverter on the other side.

The connection device further comprises a power conductor 8, for each inverter, connected at one of the ends thereof to the power output socket 4, and at the other end thereof to the power input plug 6 of the connector 5. Each power conductor is connected in series with a controlled switch 9 equipped with a control input 10, said control input being coupled to the control connector 7. The controlled switch is designed to command closing thereof if at least one electrical contact is established between the second output of the unit and the control connector 7 of the connector.

In a case that is not represented, coupling between the control input and the control connector could be achieved by means of a single electrical conductor. In this particular case, establishment of an electrical contact between the second output of the unit and the control connector of the connector constitutes the only condition to activate closing of the controlled switch. In other non-represented embodiments, other means of coupling between the control connector and the control input of the controlled switch can be envisaged, for example coupling means by electromagnetic waves.

In the embodiment of the invention represented in FIG. 1, coupling between the control connector 7 and the control input 10 of the controlled switch 9 is achieved by means of a control conductor 12 and control means, in this instance a relay 11. The control means, i.e. the relay 11, under certain conditions set out hereafter, enable an electrical contact to be established between the control connector 7 and the control input 10 of the switch 9.

In the case represented in FIG. 1, the connection device is, for each inverter, provided with a monitoring connector 13 designed to be connected to a monitoring output 14 of the inverter delivering monitoring signals representative of the operating state of this same inverter. Thus, in this particular case, closing of the controlled switch 9 is activated if the following three conditions are fulfilled:
an electrical contact is established between the monitoring output 14 and the monitoring connector 13 of the connection device 1,
an electrical contact is established between the second output of the unit and the control connector 7.

In the embodiment represented in FIG. 1, disconnection of a power input plug 6 is accompanied by almost simultaneous or prior disconnection of the control connector. In this way, such a disconnection of a power input plug 6 results in automatic opening of the controlled switch 9, which enables the power input plug to be uncoupled from the power conductors on the power output socket side, which socket is still live. In this way, once they are disconnected, the power input plugs 6 do not carry any electrical load and can be handled without any risk for the user.

As described above, in the case represented in FIG. 1, the control means, i.e. the relay 11, under certain conditions, enable an electrical contact to be established between the control connector 7 and the control input 10 of the switch 9. The control means, i.e. the controlled switch 11, comprise a control input 15 coupled to the monitoring connector 13 by means of an electric cable 16 and a connection interface 17. In other embodiments, not represented, other means of coupling between the monitoring connector and the control input of the relay can be envisaged, for example coupling means by electromagnetic waves.

What is meant by monitoring connector of the connector are means enabling connection and coupling between on the one side the monitoring output of the unit, for example the inverter, and on the other side the control input of the control means, i.e. the relay. In the case represented in FIG. 1, the monitoring connector referenced 13 is connected to the inverter. This monitoring connector 13 is moreover coupled to the control input 15 of the controlled switch 11 by means of an electric cable 16 via the interface 17. In other embodiments, not represented, the monitoring connector could be a socket located on the output housing 1, for example at the location of the connection interface 17, and enabling electrical coupling between the monitoring output 14 of the inverter and the control input 15 of the relay 11 via, for example, an electric cable integral or not to the inverter.

The monitoring output of an electrical power supply unit, such as an inverter, can be of the watchdog type, i.e. delivering signals representative of operation of the unit, as is the case of the output 14 represented in FIG. 1.

The power supply units connected by the connection device, for example the inverters, can also comprise communication outputs enabling synchronization signals with other units connected in parallel to be sent and received. The connection device can comprise communication connectors and communication means enabling these communication outputs to be connected and placed in contact.

In the example represented in FIG. 1, each inverter 2 comprises one communication output 18. The connection device comprises a communication connector 19, each of these communication connectors being connected by a communication cable 20 and the connection interfaces 17. In the example of FIG. 1, the monitoring connector 13 and the communication connector 19, designed to be connected to the corresponding outputs of each inverter, are securedly affixed to one another or form a single connector. In other embodiments, not represented, the monitoring and communication connectors can be separate.

In the example represented in FIG. 1, the communication cable 20 is partially inside the connection device, and more particularly inside the output housing 1. In other embodiments, not represented, the communication cable can be outside the connection device. Moreover, the communication outputs can enable star- or serial connection of the electrical power supply units.

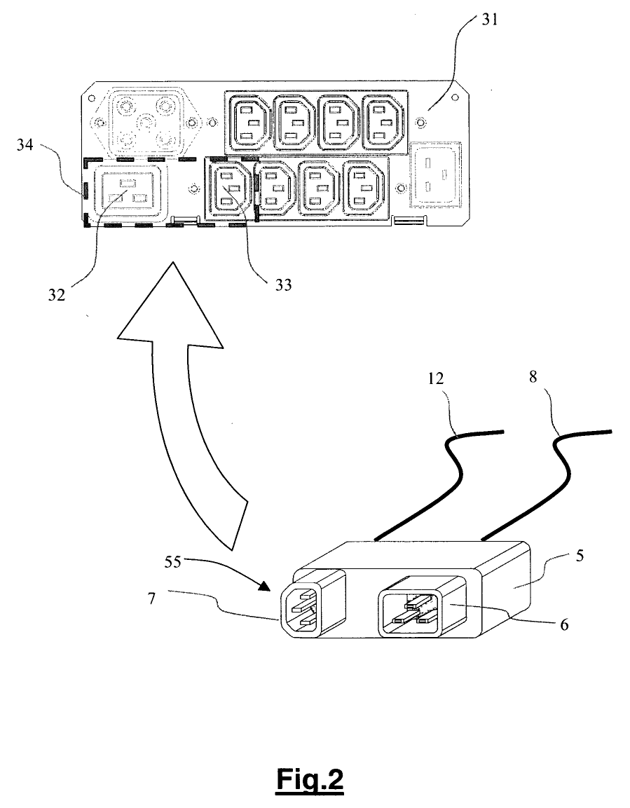

An example of a connector of the connection device of the invention is represented in FIG. 2, as is the face of an inverter whereto this connector is designed to be connected. The connector 5 is represented with the power input plug 6 and the control connector 7 of the detection means 55 respectively connected to the power conductor 8 and to the control conductor 12.

The face 31 of the inverter, whereto the connector 5 is designed to be connected, also called the mounting plate, comprises a first output 32 and a second output 33 designed to respectively receive the power input plug 6 and the control connector 7. In this example, the first output 32 corresponds to a power output of the inverter able to deliver a current of 16 amperes and the second output 33 corresponds to another output of the inverter able to deliver a current of 10 amperes.

The location of the connector 5 on the mounting plate of the inverter is represented by an outline in a dotted line referenced 34. The power input plug 6 and the control connector 7 of the connector represented in FIG. 2 are securedly affixed to one another and are assembled in such a way that their directions of insertion are the same, which enables substantially simultaneous connection of the two connectors. In other embodiments, not represented, the control connector can be fitted slightly withdrawn from the power input socket so as to ensure that, when connection of said connector to the unit is performed, the electrical contact between the first output of the unit and the power input plug is established after the electrical contact between the second output of the unit and the control connector.

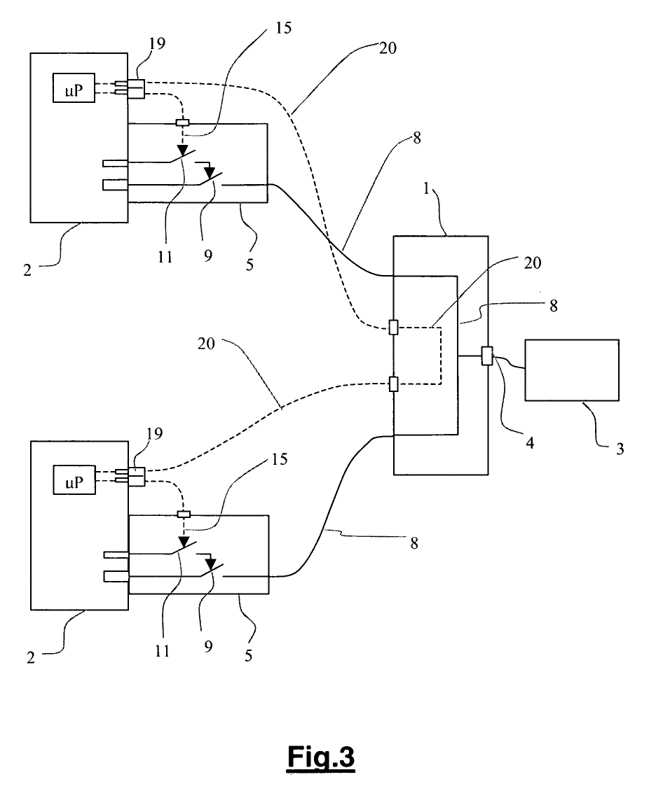

In the connection device represented in FIG. 3, for each inverter 2, the controlled switch 9 and the controlled switch 11 are fitted in the corresponding connector 5. In this case, the main function of the output housing 1 is to support the power output socket 4. As in the connection device of FIG. 1, the output housing 1 comprises a communication cable 20 constituting the link between the communication outputs of the inverters, via the communication connectors 19.

The advantages of the configuration of the connection device of FIG. 3 in comparison with that of FIG. 1 are the simplicity of the connection device and the reduction of the number of wires between the units.

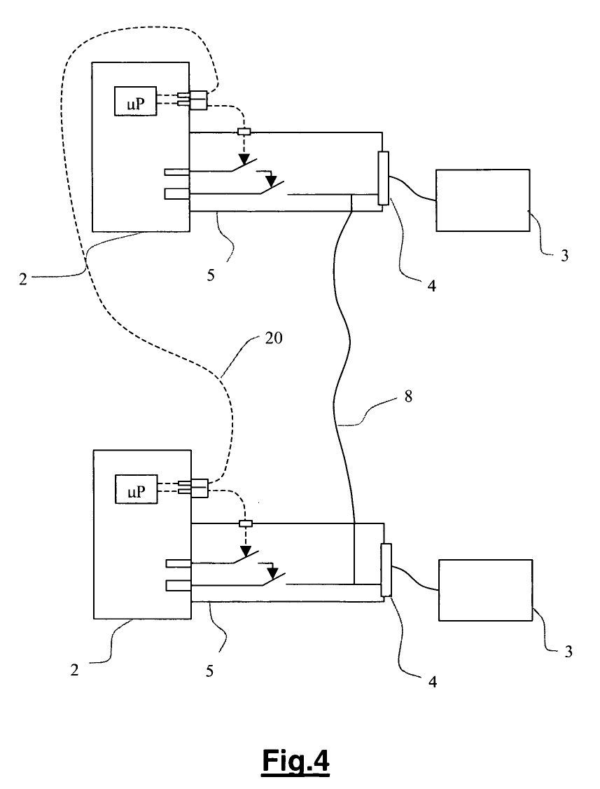

In the connection device represented in FIG. 4, each connector 5 is used as support for a power output socket 4. In this case, the load 3 can be connected to the power output socket of one or the other of the connectors. In other cases, a connector can comprise several power output sockets, which enables several loads to be electrically supplied via a single connector and/or via different connectors. With respect to the devices of FIGS. 1 and 3, the at least one power output socket 4, the power conductors 8 and the communication cable 20 are no longer centralized by means of an output housing.

The advantages of the configuration of the connection device of FIG. 4 in comparison with that of FIG. 1 or FIG. 3 are the reduction of the number of wires between the connection device and the units, the possibility of fitting a large number of electrical power supply units in parallel, and the absence of a common housing for all the electrical power supplies.

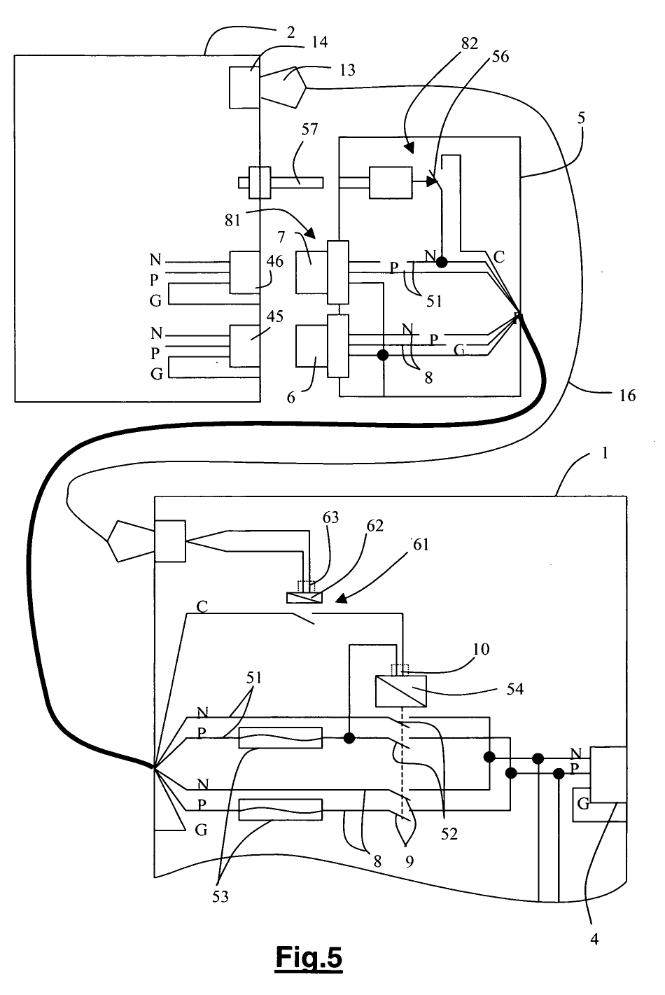

The connection device represented in FIG. 5 comprises an output housing 1 enabling several inverters to be connected in parallel by means of connectors. In the case of FIG. 5, the output housing 1 is only partially represented and only comprises the elements associated with connection of a single inverter 2.

The connector 5 comprises a power input plug 6 and a control plug 7 of the first detection means 81, the two plugs operating in conjunction with one another in such a way that their directions of insertion in the corresponding outputs 45 and 46 of the inverter are oriented in the same direction. This enables an electrical contact to be established substantially simultaneously between the plugs 6 and 7 and the corresponding outputs 45 and 46. In the case represented in FIG. 5, the two plugs 6 and 7 are single-phase plugs designed to be connected to two power output sockets of the inverter.

The connection device comprises power conductors 8 connected on one side to the power output socket 4 and on the other side to the power input plug 6 of the connector 5. Controlled switches 9 provided with a control input 10 are connected in series to each of the power conductors, i.e. the phase and neutral. The connection device also comprises additional power conductors 51 connected on the one side to the same power output socket 4 and on the other side to the control plug 7 of the connector 5. An additional controlled switch 52 comprising the same control input 10 is connected in series to each of the additional power conductors, i.e. the phase and neutral. Fuses 53 are connected in series to the power conductors 8 and 51 corresponding to the phase. The controlled switches 9 and 52 comprise a control part, i.e. a relay 54, connected to the control input 10 common to the set of controlled switches. The control input 10 is itself coupled to the control connector 7 of the first detection means 81 by means of power conductors 51 corresponding to the phase and the neutral.

The relay 54 and the control input 10 of the controlled switches 9 and 52 enable closing of these switches to be commanded if at least one electrical contact is established between the control connector 7 and the corresponding output 46 of the inverter. To do this, the control input 10 being connected between the phase and neutral of the control connector 7, the electrical contact between the control connector 7 and the corresponding output of the inverter enables a current to flow in the control input 10. However, in the case of FIG. 5, the electrical contact between the control connector 7 of the first detection means 81 and the corresponding output of the inverter is a necessary but not sufficient condition for closing the controlled switches.

Indeed, the connector 5 of the connection device of FIG. 5 also comprises second detection means 82 designed to detect connection of the connector 5 to the inverter, and this detection constitutes a second condition for closing the controlled switches 9 and 52. The control input 10 of the controlled switches 9 and 52 is also coupled to the second detection means 82 so that closing of these controlled switches can only be activated if connection of the connector to the unit is detected. To do this, the second detection means 82 comprise a contactor 56, which is a mechanical contactor, establishing an electrical contact when it is mechanically activated. The inverter 2 is for its part provided with a protuberance 57 designed to operate in conjunction with the mechanical actuator of the contactor 56 to activate said contactor when connection of the connector 5 to the inverter 2 is established. The mechanical actuator of the contactor 56 can be located in the connector so as to limit the accessibility thereof by the user. Moreover, the contactor 56 is connected on the one side to the conductor corresponding to the neutral of the control connector 7 and on the other side to the control input 10 of the controlled switches 9 and 52. In this way, when connection is detected, an electrical contact is established between the neutral and phase of the control connector by means of the control input 10. Thus, if an electrical contact is also established between the control connector 7 and the corresponding output of the inverter, a current can be generated on the control input 10, enabling the controlled switches 9 and 52 to be closed. However, in the case of FIG. 5, establishment of an electrical contact between the control connector 7 and the corresponding output of the inverter and detection of connection of the inverter are two necessary but not sufficient conditions for closing the controlled switches.

Indeed, the connection device of FIG. 5 also comprises, for each inverter, a monitoring connector 13 designed to be connected to a monitoring output 14 of the inverter delivering monitoring signals representative of the operating state of this inverter. In the embodiment of FIG. 5, connection of the monitoring connector and acquisition of monitoring signals representative of normal operation of the inverter constitutes a third condition for closing the controlled switches 9 and 52. To do this, the connection device comprises, for each inverter, a second controlled switch 61 connected in series on one of the branches of the control input 10. Thus, closing of this second switch is one of the conditions enabling a current to flow in the control input 10 to close the controlled switches 9 and 52. This second controlled switch comprises a relay 62 and a control input 63 enabling said switch to be closed when the monitoring connector 13 is connected to the corresponding output of the inverter and when the monitoring signals are representative of normal operation of the inverter.

It should be noted that the means enabling coupling between the control input 10, the control connector 7 of the first detection means 81, the detection means 82 and the monitoring connector 13 can be any suitable means known to those skilled in the art. In the case of FIG. 5, these coupling means comprise electric conductors. For example, these means can also comprise electromagnetic coupling means.

The device of FIG. 5 enables an excellent safety level to be achieved. The presence of an electric voltage on the power plug can in fact only be established if said plug is correctly connected to the power output socket of the inverter. The configuration of the power input plug 6 and of the control connector 7 of the first detection means 81, the presence of second detection means 82 and the presence of monitoring means 61, 62 and 63 connected to the monitoring connector 13 provide three levels of safety enabling any incident to be prevented.

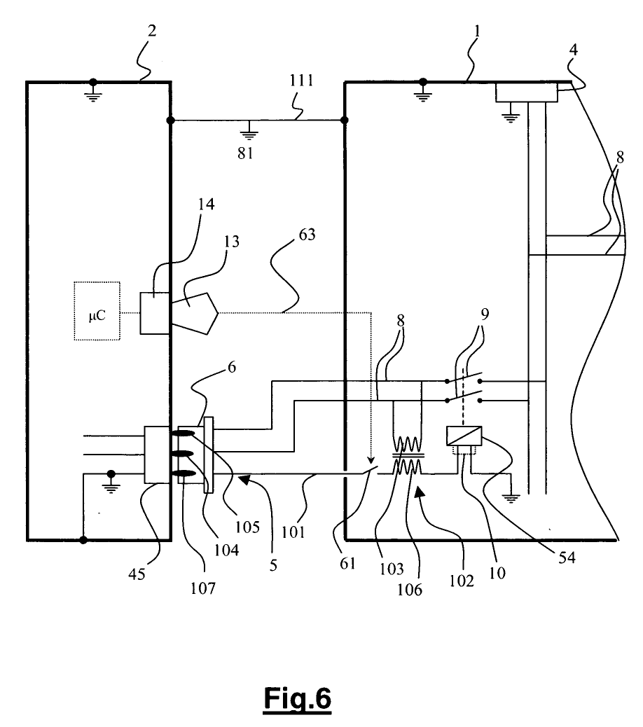

The connection device represented in FIG. 6 comprises an output housing 1 enabling several inverters to be connected in parallel by means of connectors. As for FIG. 5, the output housing 1 is only partially represented and only comprises the elements associated with connection of a single inverter 2. The connector 5 comprises a single-phase power input plug 6 designed to be connected to a power output socket 45 of the inverter.

The connection device comprises power conductors 8 connected on the one side to the power output socket 4 and on the other side to the power input plug 6 of the connector 5. Controlled switches 9 are connected in series to each of the power conductors, i.e. to the phase conductor and the neutral conductor. The controlled switches 9 comprise a control part, i.e. a relay 54. The control input 10 of the controlled switches is connected in series with the ground conductor 101 of the power input plug 6.

Generally, the connection device comprises detection means comprising means for detecting continuity of electrical conduction. The means for detecting continuity of electrical conduction can be applied to any electrical conductor, such as a pin or plug of the connector 5 of the connection device, presenting a given electrical potential. What is meant by electrical potential is any electric reference present on this electrical conductor and able to carry the current necessary for closing controlled switches, for example the controlled switches 9 by means of the relay 54. The means for detecting continuity of electrical conduction are advantageously applied to the grounds of the connection device and of the electrical power supply units. In the latter case, the means for detecting continuity of electrical conduction are called means for detecting ground continuity.

The connection device 1 represented in FIG. 6 comprises detection means comprising, and in fact essentially composed of, means for detecting ground continuity. The means for detecting ground continuity for their part comprise a transformer 102. The latter is equipped with a primary winding 103 the ends whereof are connected to the power conductors 8 of the power input plug 6, and more precisely connected via the power conductors to the neutral pin 104 and phase pin 105 of the power input plug 6. The transformer 102 is also equipped with a secondary winding 106 connected in series with the ground conductor 101. More precisely, the secondary winding is connected on one side to the ground pin 107 of the power input plug 6 and on the other side to the control input 10 of the controlled switches 9. The relay 54 enables closing and opening of the controlled switches 9 to be commanded if a ground continuity is established on the command input 10, i.e. between the input terminals of the relay 54.

However, in the case of FIG. 6, connection of the power input plug 6 is a necessary but not sufficient condition for closing the controlled switches 9. To close the controlled switches, a ground continuity has to be obtained by connecting the ground of the electrical power supply units to that of the connection device. In the case of FIG. 6, this ground continuity is achieved by a second ground conductor 111 between the inverter 2 and the connection device 1.

However, in the case of FIG. 6, connection of the power input plug 6 and connection of the grounds by a second ground conductor 111 are two necessary but not sufficient conditions for closing the controlled switches 9. Indeed, the connection device of FIG. 6 also comprises a monitoring connector 13, for each inverter, which connector is designed to be connected to a monitoring output 14 of the inverter delivering monitoring signals representative of the state of operation of this inverter. The connection device also comprises, for each inverter, a second controlled switch 61 connected in series with the ground conductor 101 of the power input plug 6. This second controlled switch comprises a control input 63 enabling closing of said switch when the monitoring connector 13 is connected to the corresponding output of the inverter and when the monitoring signals are representative of normal operation of the inverter. Thus, closing of this second controlled switch 61 constitutes another condition for obtaining establishment of the ground continuity. Thereby, in the embodiment of FIG. 6, connection of the monitoring connector and acquisition of monitoring signals representative of normal operation of the inverter constitutes a third condition for closing the controlled switches 9.

The device of FIG. 6 enables an excellent safety level to be achieved. Indeed, the presence of an electrical voltage on the power input plug can only be established if said plug is correctly connected to the power output of the inverter. Moreover, connection of the grounds and connection of the monitoring connector 13 enable two other safety levels to be obtained enabling any incident to be prevented.

One advantage of the connection device is that it enables disconnection of one of the electrical power supply units without any risk for the user. This objective is achieved by means of a device not requiring any modification of the electrical power supply units, in particular of the mini mounting plate of these units.

1. Device for parallel connection of a plurality of electrical feeder units comprising at least one power output socket designed to deliver electrical power supplied by the plurality of units, and comprising for each unit:
a connector equipped with a power input plug designed to be connected to a first electrical output of a unit, and
at least one power conductor between said power input plug and the power output socket, wherein:
the connector comprises detection means designed to detect connection of said connector to the unit,
and at least one controlled switch is connected in series to said at least one power conductor, the at least one controlled switch comprising a control input, said control input being coupled to the detection means, detection of connection of the connector to the unit enabling closing of said at least one controlled switch.

2. Device according to claim 1, characterized in that the detection means comprise means for detecting continuity of electrical conduction.

3. Device according to claim 2, wherein the means for detecting continuity of electrical conduction are applied to the grounds.

4. Device according to claim 2, wherein the means for detecting continuity of electrical conduction comprise a transformer.

5. Device according to claim 4, wherein the transformer is equipped:
with a primary winding each end whereof is connected to a power conductor of the power input plug, and
with a secondary winding connected in series with a ground conductor of the power input plug.

6. Device according to claim 1, wherein the detection means comprise a contactor.

7. Device according to claim 6, wherein the contactor of the detection means is a mechanical contactor, connection of the connector to the unit being detected by mechanical activation of the contactor.

8. Device according to claim 6, wherein the contactor of the detection means is an optical contactor, connection of the connector to the unit being detected by optical activation of the contactor.

9. Device according to claim 6, wherein the contactor of the detection means is a ground contactor, connection of the connector to the unit being detected by placing a ground associated with the connector in contact with a ground of the unit.

10. Device according to claim 1, wherein
the detection means comprise a control connector designed to be connected to a second electrical output of the unit, said control connector operating in conjunction with the power input plug so that, when the connector is connected to the unit, an electrical contact between the first output and the power input plug is established substantially at the same time or subsequent to establishment of an electrical contact between the second output, and
the control input is coupled to the control connector, establishment of an electrical contact between the second output of the unit and the control connector enabling closing of said at least one controlled switch.

11. Device according to claim 10, wherein the power input plug and the control connector are integral to one another and the direction of insertion of said plug and said connector are the same.

12. Device according to claim 11, wherein the power input plug and the control connector are assembled by overmoulding or moulding.

13. Device according to claim 11, wherein the power input plug and the control connector are fitted on a metal or plastic housing.

14. Device according to claim 10, wherein the control connector is connected to the output socket by at least one additional power conductor, at least one additional controlled switch being connected in series on said at least one additional power conductor, said at least one additional controlled switch being associated with the control input.

15. Device according to claim 1, comprising, for each unit of the plurality of electrical feeder units:
at least one monitoring connector designed to be connected to at least one monitoring output of the unit delivering monitoring signals representative of the state of operation of said unit, and
the control input of the at least one controlled switch is also coupled to the monitoring connector so that closing of said at least one controlled switch can only be activated if the at least one monitoring connector is connected to the monitoring output and if the monitoring signals are representative of normal operation.

16. Device according to claim 15, wherein the control input of the at least one controlled switch is coupled to the monitoring connector by a second control input of a second controlled switch connected in series between the control connector and said control input.

17. Device according to claim 1, wherein the at least one controlled switch, for each unit, is fitted in the connector.

18. Device according to claim 17, wherein the at least one power output socket is fitted on at least one connector.

19. Device according to claim 1, wherein the at least one power output socket is fitted on an output housing.

20. Device according to claim 19, further comprising communication connectors and means for communication between said communication connectors, said connectors being designed to be connected with communication outputs of each unit.

21. Device according to claim 19, wherein the at least one controlled switch, for each unit, is fitted in the output housing.

22. Device according to claim 19, wherein the at least one controlled switch, for each unit, is fitted in the connector.

23. Device according to claim 1, wherein the electrical power supply units are inverters.

24. Device according to claim 1, wherein it is suitable for connection of two electrical power supply units in parallel.
